(19) United States
(12) Patent Application Publication
(10) Pub. No.: US 2024/0372821 A1
(43) Pub. Date: Nov. 7, 2024

(54) NETWORK COMMUNICATION APPARATUS AND OPERATING METHOD THEREOF

(71) Applicant: MEDIATEK Inc., Hsinchu City (TW)

(72) Inventors: Ling-Yuan CHEN, Hsinchu City (TW); Wei-Han KUO, Hsinchu City (TW); Sheng-Wen HSU, Hsinchu City (TW); Chung-Chi LO, Hsinchu City (TW)

(21) Appl. No.: 18/641,675

(22) Filed: Apr. 22, 2024

Related U.S. Application Data
(60) Provisional application No. 63/500,063, filed on May 4, 2023.

(51) Int. Cl. H04L 49/9057; H04L 47/62; H04L 49/9005

(52) U.S. Cl. CPC H04L 49/9057; H04L 47/6225; H04L 49/9005

(57) ABSTRACT

A network communication apparatus, includes a dispatch device, a first core group with several parallel core units and a second core group with at least one serial core unit. The dispatch device receives several packets contained in several first packet flows, and configured to dispatch several meta data to the parallel core units through several first data flows, and the meta data contain tunnel parameters of the packets. Furthermore, the at least one serial core unit receives the meta data from the parallel core units through several second data flows.

This application claims the benefit of U.S. provisional application Ser. No. 63/500,063, filed May 4, 2023, the entirety of which is incorporated herein by reference.

### TECHNICAL FIELD

The present disclosure relates to a communication apparatus, and more particularly relates to a network communication apparatus with a “step-based multi-processor” architecture and its operating method.

### BACKGROUND

In a tunnel network, a maximum-transmission-unit (MTU) mechanism is utilized to deal with packets with great packet lengths beyond the capability of the network communication apparatus in the tunnel network. In order to perform the MTU mechanism, packet processing is performed on the packets such that the packets may be transmitted between several private networks and cross a public network in the overall tunnel network.

However, in order to perform packet processing for the MTU mechanism, the network communication apparatus may require more memory space and computing power and hence get heavy workload.

In view of the above issues, it is desirable to have an improved network communication apparatus with a “step-based multi-processor” architecture and a “shared memory” configuration.

### SUMMARY

According to an aspect of the present disclosure, a network communication apparatus is provided. The network communication apparatus includes the following elements. A first core group, including several parallel core units. A dispatch device, for receiving several packets contained in several first packet flows, and configured to dispatch several meta data to the parallel core units through several first data flows, wherein the meta data contain tunnel parameters of the packets. A second core group, including at least one serial core unit, wherein the at least one serial core unit receives the meta data from the parallel core units through several second data flows.

According to another aspect of the present disclosure, an operating method for operating a network communication apparatus is provided. The network communication apparatus includes a dispatch device, a first core group with a plurality of parallel core units and a second core group with at least one serial core unit. The operating method includes the following steps. Receiving a plurality of packets contained in a plurality of first packet flows, by the dispatch device. Dispatching a plurality of meta data to the parallel core units through a plurality of first data flows, by the dispatch device. Receiving the meta data from the parallel core units through a plurality of second data flows, by the at least one serial core unit. The meta data contain tunnel parameters of the packets.

### BRIEF DESCRIPTION OF THE DRAWINGS

FIG. 1 is a functional block diagram of a network communication apparatus 1000 according to an embodiment of the present disclosure.

FIG. 2A, which is a schematic diagram illustrating an exemplary operation of the dispatch device 100.

FIG. 2B, which is a schematic diagram illustrating another exemplary operation of the dispatch device 100.

FIG. 3, which is a schematic diagram illustrating an exemplary operation of the core units 21-23 of the core group 200.

FIG. 4A is a schematic diagram illustrating an exemplary operation of the core units 31 and 32 of the core group 300.

FIG. 4B, which is a schematic diagram illustrating another exemplary operation of the core units 31 and 32 of the core group 300.

FIG. 4C, which is a schematic diagram illustrating still another exemplary operation of the core units 31 and 32 of the core group 300.

FIG. 5A-1 is a schematic diagram illustrating an exemplary operation of the transmitting unit 400.

FIG. 5A-2, which is a schematic diagram illustrating another exemplary operation of the transmitting unit 400.

FIG. 5B-1, which is a schematic diagram illustrating still another exemplary operation of the transmitting unit 400.

FIG. 5B-2, which is a schematic diagram illustrating yet another exemplary operation of the transmitting unit 400.

FIG. 5C-1, which is a schematic diagram illustrating an alternative exemplary operation of the transmitting unit 400.

FIG. 5C-2, which is a schematic diagram illustrating a still alternative exemplary operation of the transmitting unit 400.

FIG. 6 is a functional block diagram of a network communication apparatus 1000b according to another embodiment of the present disclosure.

FIG. 7 is a flow diagram of an operating method for the network communication apparatuses of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically illustrated in order to simplify the drawing.

### DETAILED DESCRIPTION

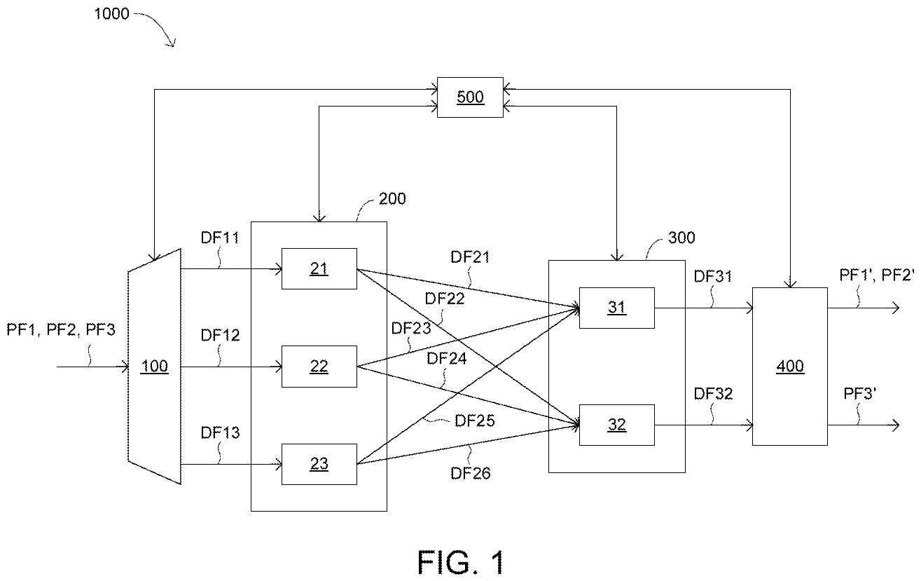

FIG. 1 is a functional block diagram of a network communication apparatus 1000 according to an embodiment of the present disclosure. The network communication apparatus 1000 is a network-connected device (e.g., an access point (AP) device) which performs packet processing in a tunnel network with a tunneling protocol. The network communication apparatus 1000 is adapted for the MTU mechanism, which may fragment packets of greater lengths into shorter ones equal to or less than the MTU size. Since the packets conform to the MTU size, the network communication apparatus 1000 may be avoided from lacking memory space. Furthermore, in the tunnel network, packets may be conveyed between several private networks and transmitted cross a public network. For security and privacy issues, the packets may be repacked (i.e., encapsulated) with headers or encrypted with security keys.

In order to comply with the MTU mechanism and the privacy/security issues in the tunnel network, the network communication apparatus 1000 may perform a huge amount of packet processing on the packets, e.g., encapsulation, decapsulation, fragmentation and reassembly. To facilitate the packet processing, the network communication apparatus 1000 utilizes a “step-based multi-processor” architecture to share and offload the efforts of packet processing. In the “step-based multi-processor” architecture, the network communication apparatus 1000 has several core groups disposed in a step-based manner. In the example of FIG. 1, the network communication apparatus 1000 includes a core group 200 and a core group 300. The core group 200 serves as a first step (i.e., a first stage) while the core group 300 serves as a second step (i.e., a second stage) in the “step-based multi-processor” architecture.

The core group 200 includes a number “N1” of core units, while the core group 300 includes a number “N2” of core units. In the example of FIG. 1, the number “N1” is equal to “3” and the number “N2” is equal to “2”. That is, the core group 200 includes three core units 21, 22 and 23, while the core group 300 includes two core units 31 and 32. The core units 21-23 of the core group 200 are communicatively coupled to the core units 31 and 32 of the core group 300. Each of the core units 21-23 and 31-32 may be a single processor, e.g., a central processing unit (CPU), a graphic processing unit (GPU) or a micro control unit (MCU). Alternatively, each of the core units 21-23 and 31-32 may be a processing core within a processor.

The core group 200 may operate with a different computing mechanism from the core group 300. The core units 21-23 of the core group 200 may perform parallel processing on the packets, hence the core units 21-23 may be referred to as “parallel core units”. On the other hand, the core units 31 and 32 of the core group 300 may perform serial processing on the packets with a central computing policy, hence the core units 31 and 32 may be referred to as “serial core units” or “centralized core units”. The parallel processing and the serial processing may be, e.g., encapsulation, decapsulation, fragmentation or reassembly performed on the packets.

Other than the core groups 200 and 300, the network communication apparatus 1000 further includes a dispatch device 100, a transmitting unit 400 and a storage unit 500. The dispatch device 100 is disposed in a stage prior to the stage of the core group 200, and the transmitting unit 400 is disposed in a stage subsequent to the stage of the core group 300. The dispatch device 100 is communicatively coupled to the core units 21-23 of the core group 200, and the transmitting unit 400 is communicatively coupled to the core units 31 and 32 of the core group 300. The storage unit 500 is a memory or a disk drive referred to as a “shared memory”, which is shared and accessible by each of the dispatch device 100, the core units 21-23 and 31-32, and the transmitting unit 400.

The dispatch device 100 is an individual hardware element, e.g., a module of a System-on-Chip (SoC), an individual application specific integrated chip (ASIC) or field programmable gate array (FPGA) which is separated from the core units 21-23 and 31-32. The dispatch device 100 is configured to receive a series of packets contained in several packet flows PF1, PF2 and PF3, and the dispatch device 100 may carry meta data which contain packet information associated with these packets. The packet information may be provided by an external system of a previous stage (not shown in FIG. 1) of the dispatch device 100. Furthermore, the dispatch device 100 is configured to dispatch these packets to the core units 21-23. In the example of FIG. 1, some packets in the packet flows PF1, PF2 and PF3 are dispatched to the core unit 21 through a data flow DF11, while some other packets are dispatched to the core unit 22 through a data flow DF12, and still other packets are dispatched to the core unit 23 through a data flow DF13.

The core unit 21 receives and processes packets in the data flow DF11 and delivers the processed packets to the core units 31 and 32 through two data flows DF21 and DF22 respectively. Furthermore, the core unit 22 receives and processes packets in the data flow DF12 and delivers the processed packets to the core units 31 and 32 through two data flows DF23 and DF24 respectively. Moreover, the core unit 23 receives and processes packets in the data flow DF13 and delivers the processed packets to the core units 31 and 32 through two data flows DF25 and DF26 respectively.

Similar to the operations of the core units 21-23 of the core group 200, the core unit 31 of the core group 300 receives and processes packets in the data flows DF21, DF23 and DF25 and delivers the processed packets to the transmitting unit 400 through a data flow DF31. Furthermore, the core unit 32 of the core group 300 receives and processes packets in the data flows DF22, DF24 and DF26 and delivers the processed packets to the transmitting unit 400 through a data flow DF32.

The transmitting unit 400 is used to transmit packet flows PF1′, PF2′ and PF3′ corresponding to the data flows DF31 and DF32, and these packet flows PF1′, PF2′ and PF3′ are sent to an external device (not shown in FIG. 1). The packet flows PF1′, PF2′ correspond to the data flow DF31, while another packet flow PF3′ corresponds to the data flow DF32. Furthermore, the storage unit 500 is used to store packets associated with the data flows DF31 and DF32, and these packets stored in the storage unit 500 are accessible by each of the dispatch device 100, the core units 21-23 and 31-32, and the transmitting unit 400.

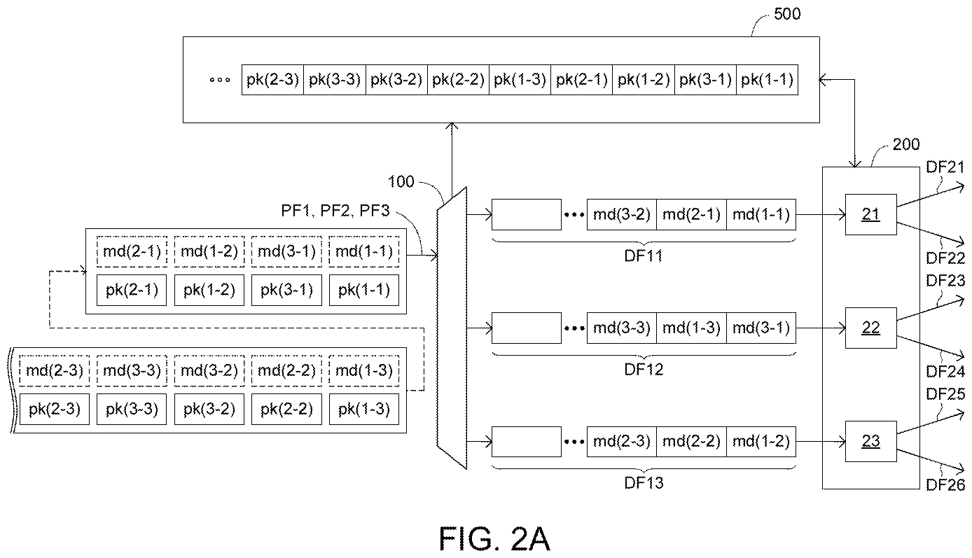

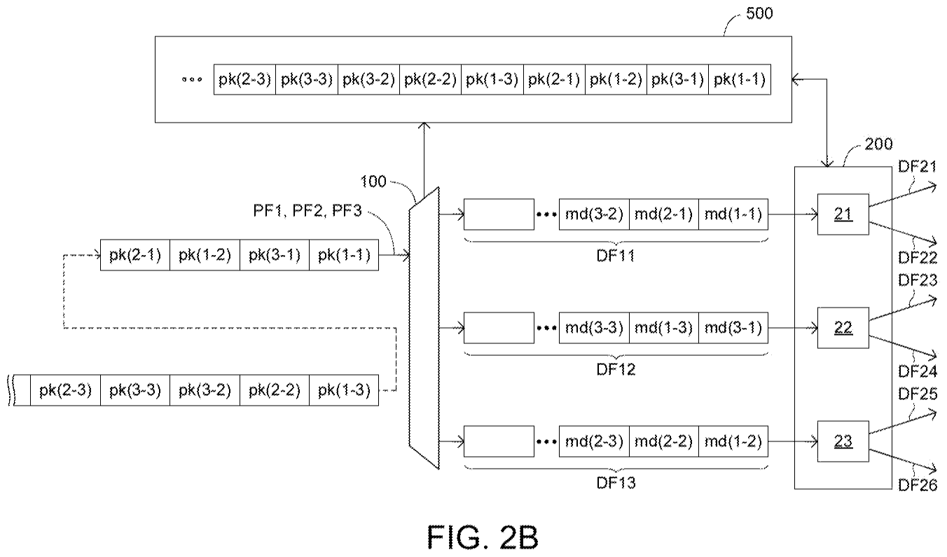

Referring to FIG. 2A, which is a schematic diagram illustrating an exemplary operation of the dispatch device 100. The dispatch device 100 receives a series of packets pk(1-1) to pk(3-3) contained in the packet flows PF1 to PF3. Such as, the packets pk(1-1) to pk(1-3) are contained in the packet flow PF1, while the packets pk(2-1) to pk(2-3) are contained in the packet flow PF2, and the packets pk(3-1) to pk(3-3) are contained in the packet flow PF3. The packet flows PF1 to PF3 are transmitted in a single data path to the dispatch device 100, and the packets pk(1-1) to pk(1-3) in the packet flow PF1 are scrambled with the packets pk(2-1) to pk(2-3) in the packet flow PF2 and the packets pk(3-1) to pk(3-3) in the packet flow PF3, but the packets in the same packet flow are kept in order. Such as, the packets in the packet flow PF1 are kept in an order of pk(1-1), pk(1-2) and pk(1-3), and these packets pk(1-1) to pk(1-3) are scrambled with the packets pk(3-1) and pk(2-1). Likewise, the packets in the packet flow PF2 are kept in an order of pk(2-1), pk(2-2) and pk(2-3), which are scrambled with the packets pk(1-3), pk(3-2) and pk(3-3). Moreover, the packets in the packet flow PF3 are kept in an order of pk(3-1), pk(3-2) and pk(3-3), which are scrambled with the packets pk(1-2), pk(2-1), pk(1-3) and pk(2-2).

The packets pk(1-1) to pk(3-3) have corresponding meta data md(1-1) to md(3-3) respectively, and these meta data md(1-1) to md(3-3) may be also contained in the packet flows PF1, PF2 and PF3. The meta data md(1-1) to md(3-3) may contain corresponding information of packets pk(1-1) to pk(3-3), such as, the meta data md(1-1) is related to the packet pk(1-1) and contains some information of the packet pk(1-1), while other meta data md(1-2) to md(3-1) contain some information of corresponding packets pk(1-2) to pk(3-1) respectively. For example, the meta data md(1-1) to md(3-1) may contain packet information related to the packets pk(1-1) to pk(3-1), and such packet information may be provided by an external system (not shown in FIG. 2A). The dispatch device 100 may only transmit the meta data md(1-1) to md(3-3) to the core units 21-23, while the packets pk(1-1) to pk(3-3) may not be transmitted to the core units 21-23 but stored in the storage unit 500 instead. When stored in the storage unit 500, the packets pk(1-1) to pk(3-3) take the same order as that in the packet flows PF1, PF2 and PF3. That is, the storage unit 500 stores the packets in an order of: pk(1-1), pk(3-1), pk(1-2), pk(2-1), pk(1-3), . . . pk(2-3), etc.

On the other hand, the dispatch device 100 performs a dispatching operation to dispatch the meta data md(1-1) to md(3-3) to the core units 21-23. In one example, the dispatching operation may be performed based on a “round robin” mechanism. Such as, the dispatch device 100 receives and processes a first round of packets pk(1-1), pk(3-1) and pk(1-2), and the corresponding meta data md(1-1), md(3-1) and md(1-2) are dispatched to the core units 21-23 by order. Then, a second round of packets pk(2-1), pk(1-3) and pk(2-2) are received and processed by the dispatch device 100, and the corresponding meta data md(2-1), md(1-3) and md(2-2) are dispatched to the core units 21-23 by order. Likewise, after receiving and processing a third round of packets pk(3-2), pk(3-3) and pk(2-3), the corresponding meta data md(3-2), md(3-3) and md(2-3) are dispatched to the core units 21-23 by order.

The meta data md(1-1), md(2-1) and md(3-2) may be delivered to the core unit 21 through the data flow DF11, and the core unit 21 may perform processing (e.g., encapsulation, decapsulation and/or fragmentation) on the corresponding packets pk(1-1), pk(2-1) and pk(3-2) in the storage unit 500. Thereafter, the core unit 21 transmits the meta data md(1-1), md(2-1) and md(3-2) to the core units 31 and 32 of FIG. 1 through the data flows DF21 and DF22 respectively. Furthermore, the meta data md(3-1), md(1-3) and md(3-3) may be delivered to the core unit 22 through the data flow DF12, and the core unit 22 performs processing on the corresponding packets pk(3-1), pk(1-3) and pk(3-3) in the storage unit 500. Thereafter, the core unit 22 transmits the meta data md(3-1), md(1-3) and md(3-3) to the core units 31 and 32 of FIG. 1 through the data flows DF23 and DF24 respectively. Likewise, the core unit 23 receives the meta data md(1-2), md(2-2) and md(2-3) through the data flow DF13, and then performs processing on the corresponding packets pk(1-2), pk(2-2) and pk(2-3) in the storage unit 500. Then, the meta data md(1-2), md(2-2) and md(2-3) are sent to the core units 31 and 32 of FIG. 1 through the data flows DF25 and DF26 respectively. The data flows DF21 to DF26 may be tunnel flows with a CAPWAP/GRE type (i.e., Control-And-Provisioning of Wireless-Access-Points protocol, and Generic-Routing-Encapsulation) or a VxLAN type (i.e., Virtual Extensible LAN). Based on the “round robin” mechanism of the dispatch device 100, the meta data md(1-1) to md(3-3) are uniformly dispatched to the core units 21-23, hence each of the core units 21-23 is responsible to process an equal number of corresponding packets in the storage unit 500. That is, based on the “round robin” mechanism the core units 21-23 may equally process corresponding packets in the storage unit 500 in a parallel manner, such that packet processing may be offloaded.

In another example, the dispatching operation may be performed based on a classification mechanism (not shown in FIG. 2A). The dispatch device 100 is configured to classify the packets pk(1-1) to pk(3-3) as various types, and then dispatch the corresponding meta deta md(1-1) to md(3-3) to the core units 21-23 based on the types of the packets pk(1-1) to pk(3-3). Such as, some packets are classified as a first type, and their corresponding meta deta are dispatched to the core unit 21. Furthermore, some other packets are classified as a second type, and their corresponding meta deta are dispatched to the core unit 22, while other meta data corresponding to packets classified as a third type are dispatched to the core unit 23. That is, the core unit 21 receives meta data associated with the first type, the core unit 22 receives meta data associated with the second type, and the core unit 23 receives meta data associated with the third type. Each of the core units 21-23 receives the meta data associated with the same classified type.

Referring to FIG. 2B, which is a schematic diagram illustrating another exemplary operation of the dispatch device 100. The example of FIG. 2B is similar to that of FIG. 2A except that, the meta data md(1-1) to md(3-3) may not be contained in the packet flows PF1, PF2 and PF3. Instead, after receiving the packets pk(1-1) to pk(3-3), the dispatch device 100 may retrieve the corresponding meta data md(1-1) to md(3-3) from headers of the packets pk(1-1) to pk(3-3).

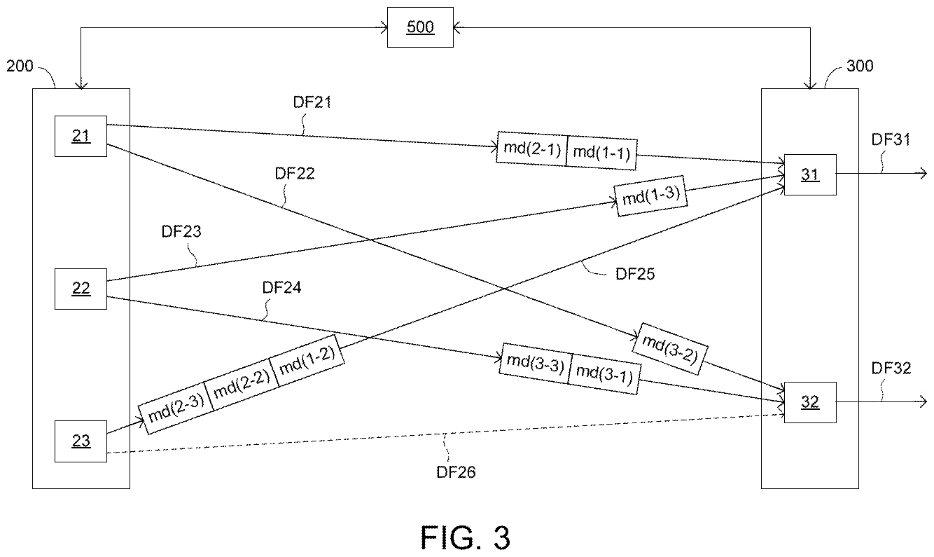

Referring to FIG. 3, which is a schematic diagram illustrating an exemplary operation of the core units 21-23 of the core group 200. The core unit 21 may process (e.g., (e.g., encapsulate, decapsulate, fragment and/or reassemble) the packets pk(1-1), pk(2-1) and pk(3-2) in the storage unit 500 (not shown in FIG. 3), and then transmit the corresponding meta data md(1-1), md(2-1) and md(3-2) to the core units 31 and 32. In the example of FIG. 3, the meta data md(1-1), md(2-1) are sent to the core unit 31 through the data flow DF21, while the meta data md(3-2) is sent to the core unit 32 through the data flow DF22.

Furthermore, the core unit 22 may process the packets pk(3-1), pk(1-3) and pk(3-3) in the storage unit 500 (not shown in FIG. 3). Then, the corresponding meta data md(1-3) is sent to the core unit 31 through the data flow DF23, while the other corresponding meta data md(3-1) and md(3-3) are sent to the core unit 32 through the data flow DF24. Moreover, the core unit 23 may process the packets pk(1-2), pk(2-2) and pk(2-3) in the storage unit 500 (not shown in FIG. 3). Then, the corresponding meta data md(1-2), md(2-2) and md(2-3) are sent to the core unit 31 through the data flow DF25, while the other subsequent meta data (not shown in FIG. 3) may be sent to the core unit 32 through the data flow DF26.

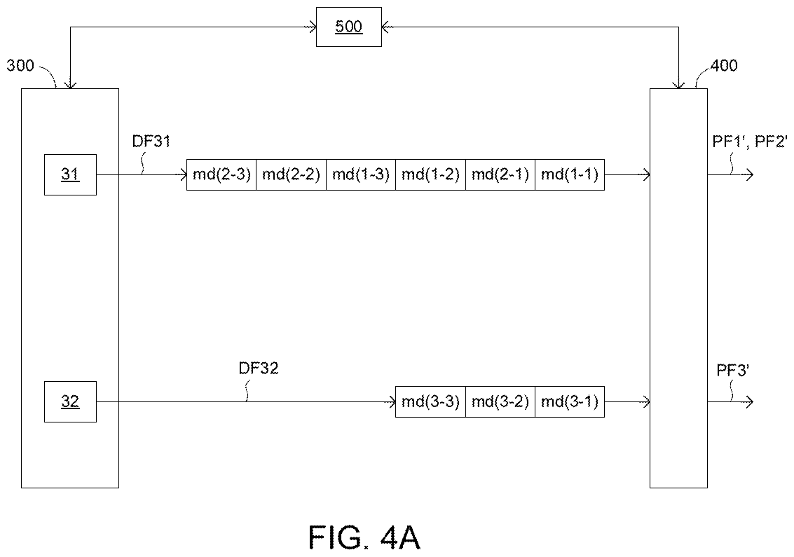

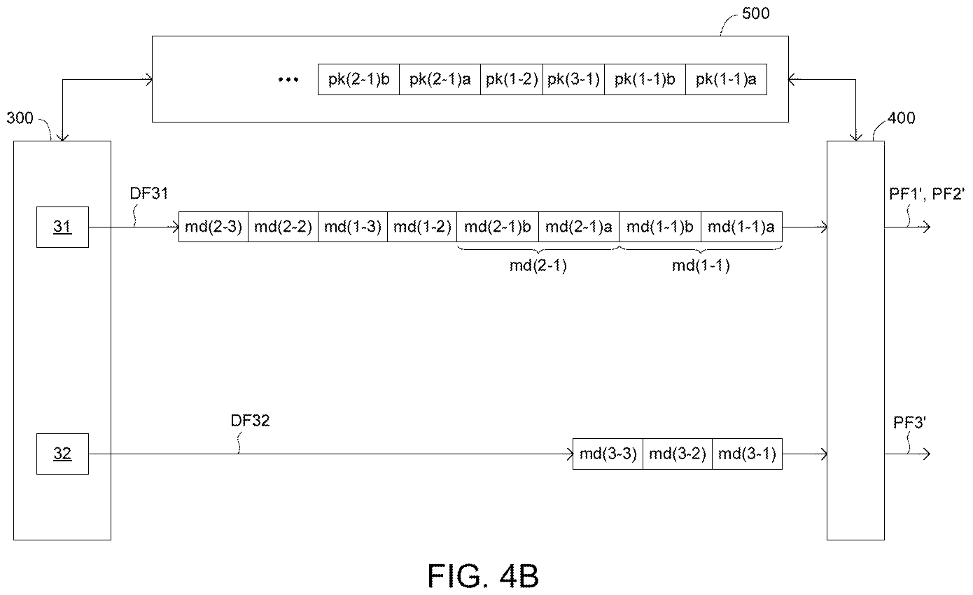

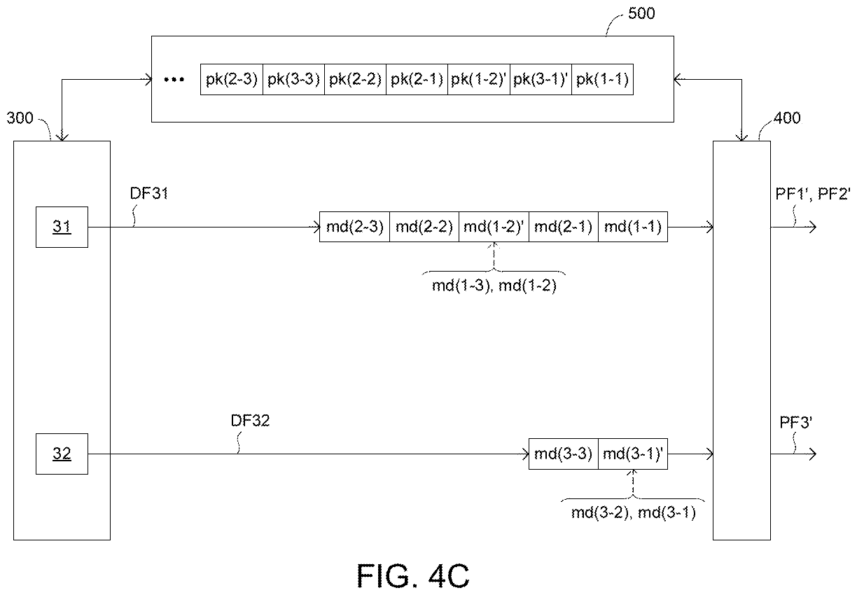

Thereafter, the core units 31 and 32 process the packets (e.g., reassembly) in the storage unit 500 and then transmit the corresponding meta data to the transmitting unit 400 through the data flows DF31 and DF32, as will be described in the following paragraphs by reference to FIGS. 4A to 4C. FIG. 4A is a schematic diagram illustrating an exemplary operation of the core units 31 and 32 of the core group 300. Referring to both FIGS. 3 and 4A, the core unit 31 receives meta data md(1-1), md(2-1) from the core unit 21 through the data flow DF21, receives meta data md(1-3) from the core unit 22 through the data flow DF23, and receives meta data md(1-2), md(2-2) and md(2-3) from the core unit 23 through the data flow DF25. Then, the core unit 31 processes the corresponding packets pk(1-1), pk(2-1), pk(1-2), pk(1-3), pk(2-2) and pk(2-3) in the storage unit 500 (not shown in FIG. 4A). Then, the core unit 31 transmits the meta data md(1-1), md(2-1), md(1-2), md(1-3), md(2-2) and md(2-3) to the transmitting unit 400 through the data flow DF31.

Furthermore, the core unit 32 receives meta data md(3-2) from the core unit 21 through the data flow DF22, and receives meta data md(3-1) and md(3-3) from the core unit 22 through the data flow DF24. Then, the core unit 32 processes the corresponding packets pk(3-1), pk(3-2) and pk(3-3) in the storage unit 500 (not shown in FIG. 4A). Then, the core unit 32 transmits the meta data md(3-1), md(3-2) and md(3-3) to the transmitting unit 400 through the data flow DF32.

Referring to FIG. 4B, which is a schematic diagram illustrating another exemplary operation of the core units 31 and 32 of the core group 300. In the example of FIG. 4B, the packets in the storage unit 500 may be fragmented by the core unit 31 or the core unit 32. Such as, the core unit 31 performs fragmenting on the packets pk(1-1), and the packet pk(1-1) is fragmented as two packets pk(1-1)a and pk(1-1)b. Furthermore, the packet pk(2-1) is fragmented as two packets pk(2-1)a and pk(2-1)b. The fragmented packets pk(1-1)a and pk(1-1)b have corresponding meta data md(1-1)a and md(1-1)b, and the fragmented packets pk(2-1)a and pk(2-1)b have corresponding meta data md(2-1)a and md(2-1)b. These meta data md(1-1)a, md(1-1)b, md(2-1)a and md(2-1)b are included in the data flow DF31 and sent to the transmitting unit 400.

Referring to FIG. 4C, which is a schematic diagram illustrating still another exemplary operation of the core units 31 and 32 of the core group 300. In the example of FIG. 4C, the packets in the storage unit 500 may be reassembled by the core unit 31 or the core unit 32. Such as, the core unit 31 reassembles two packets pk(1-2) and pk(1-3) into one packet pk(1-2)′ in the storage unit 500. The reassembled packet pk(1-2)′ has a corresponding meta data md(1-2)′ included in the data flow DF31 and to be provided to the transmitting unit 400. Likewise, the core unit 32 reassembles two packets pk(3-1) and pk(3-2) into one packet pk(3-1)′ in the storage unit 500. The reassembled packet pk(3-1)′ has a corresponding meta data md(3-1)′ included in the data flow DF32 and to be provided to the transmitting unit 400.

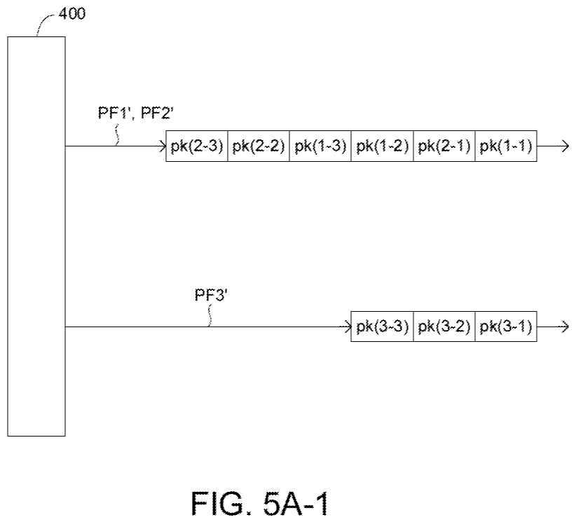

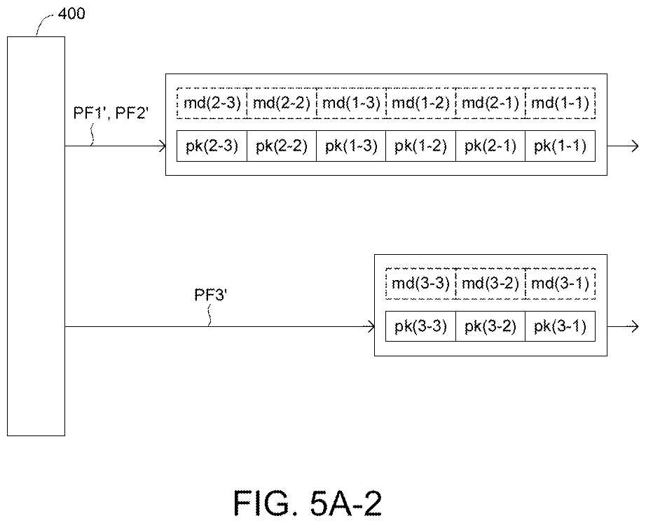

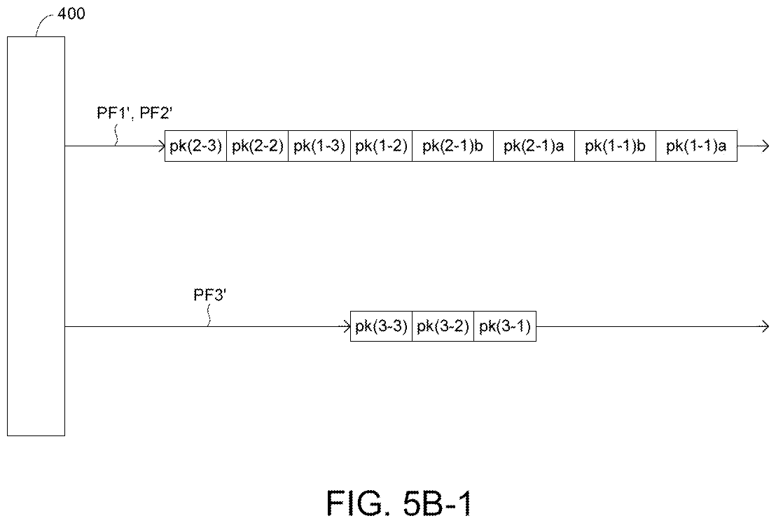

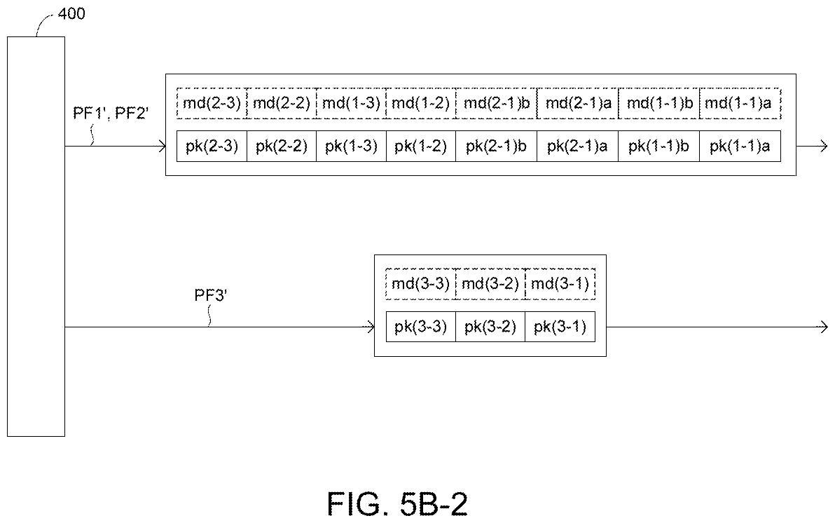

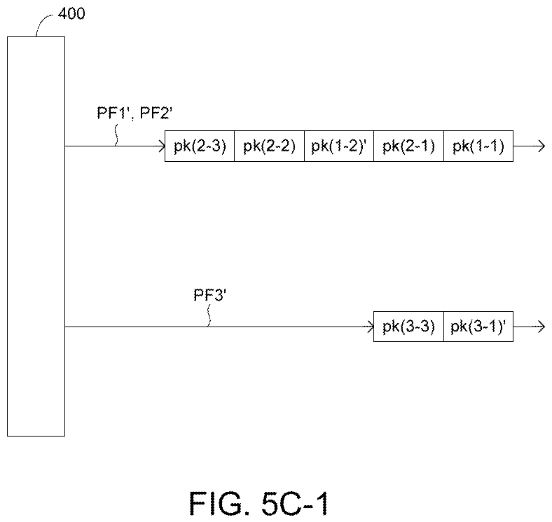

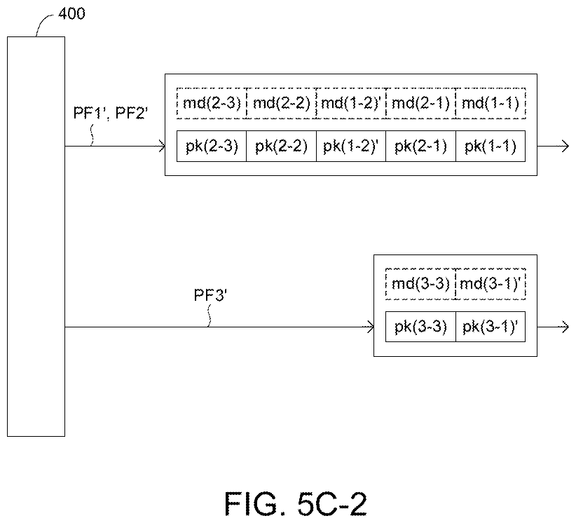

FIG. 5A-1 is a schematic diagram illustrating an exemplary operation of the transmitting unit 400. Referring to both FIGS. 4A and 5A-1, the transmitting unit 400 receives the meta data md(1-1), md(2-1), md(1-2), md(1-3), md(2-2) and md(2-3) from the core unit 31 through the data flow DF31. Based on these received meta data, the transmitting unit 400 accesses the storage unit 500 to obtain corresponding packets pk(1-1), pk(2-1), pk(1-2), pk(1-3), pk(2-2) and pk(2-3). The packets pk(1-1) and pk(1-3) are contained in the packet flow PF1′, and the packets pk(2-1), pk(2-2) and pk(2-3) are contained in the packet flow PF2′. The transmitting unit 400 transmits the packet flows PF1′ and PF2′ to the external device (not shown in FIGS. 4A and 5A-1), where the packet flows PF1′ and PF2′ correspond to the data flow DF31. The packet flows PF1′ and PF2′ are transmitted on a single data path, and the transmitting unit 400 sends the packets pk(1-1), pk(2-1), pk(1-2), pk(1-3), pk(2-2) and pk(2-3) contained in the packet flows PF1′ and PF2′ to the external device.

Likewise, the transmitting unit 400 receives the meta data md(3-1), md(3-2) and md(3-3) from the core unit 32 through the data flow DF32, and then accesses the storage unit 500 to obtain corresponding packets pk(3-1), pk(3-2) and pk(3-3). Then, the transmitting unit 400 transmits the packet flow PF3′ to the external device, where the packet flow PF3′ corresponds to the data flow DF32. In this manner, the transmitting unit 400 sends the packets pk(3-1), pk(3-2) and pk(3-3) contained in the packet flow PF3′ to the external device.

Referring to FIG. 5A-2, which is a schematic diagram illustrating another exemplary operation of the transmitting unit 400. The example of FIG. 5A-2 is similar to that of FIG. 5A-1 except that, the transmitting unit 400 may also send the meta data md(1-1) to md(3-3) to the external device. Such as, the meta data md(1-1), md(1-2) and md(1-3) are correspondingly sent to the external device in conjunction with the packets pk(1-1), pk(1-2) and pk(1-3) through the packet flow PF1. Likewise, the meta data md(2-1), md(2-2) and md(2-3) are sent to the external device with their corresponding packets pk(2-1), pk(2-2) and pk(2-3) through the packet flow PF2. Furthermore, through the packet flow PF3, the meta data md(3-1), md(3-2) and md(3-3) together with their corresponding packets pk(3-1), pk(3-2) and pk(3-3) are sent to the external device.

Referring to FIG. 5B-1, which is a schematic diagram illustrating still another exemplary operation of the transmitting unit 400. The example of FIG. 5B-1 is similar to that of FIG. 5A-1 except that, the packet pk(1-1) is fragmented as two packets pk(1-1)a and pk(1-1)b, and the packet pk(2-1) is fragmented as two packets pk(2-1)a and pk(2-1)b. That is, the example of FIG. 5B-1 corresponds to the example of FIG. 4B in which some of the packets are performed with fragmenting. The fragmented packets pk(1-1)a, pk(1-1)b, pk(2-1)a and pk(2-1)b are contained in the packet flows PF1′ and PF2′ sent by the transmitting unit 400.

Referring to FIG. 5B-2, which is a schematic diagram illustrating yet another exemplary operation of the transmitting unit 400. The example of FIG. 5B-2 is similar to that of FIG. 5B-1 except that, the packet flows PF1′, PF2′ and PF3′ transmitted by the transmitting unit 400 further include the meta data md(1-1)a, md(1-1)b, md(2-1)a, md(2-1)b, md(1-2), md(1-3), md(2-2) and md(2-3).

Referring to FIG. 5C-1, which is a schematic diagram illustrating an alternative exemplary operation of the transmitting unit 400. The example of FIG. 5C-1 is similar to that of FIG. 5A-1 except that, two packets pk(1-2) and pk(1-3) are reassembled into one packet pk(1-2)′, and two packets pk(3-1) and pk(3-2) are reassembled into one packet pk(3-1)′. That is, the example of FIG. 5C-1 corresponds to the example of FIG. 4C in which some of the packets are performed with reassembling. The reassembled packets pk(1-2)′ is included in the packet flow PF1, and the reassembled packets pk(3-1)′ is included in the packet flow PF3, which are sent to the external device.

Referring to FIG. 50-2, which is a schematic diagram illustrating a still alternative exemplary operation of the transmitting unit 400. The example of FIG. 5C-2 is similar to that of FIG. 5C-1 except that, the packet flows PF1′ and PF2′ transmitted by the transmitting unit 400 further include the meta data md(1-1), md(2-1), md(1-2)′, md(2-2) and md(2-3). Likewise, the packet flow PF3′ transmitted by the transmitting unit 400 further includes the meta data md(3-1)′ and md(3-3).

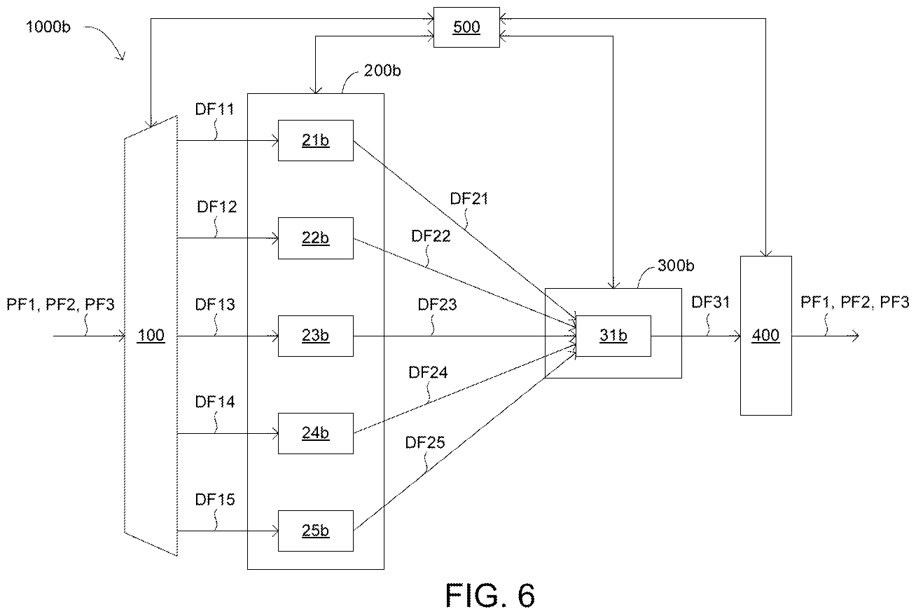

FIG. 6 is a functional block diagram of a network communication apparatus 1000b according to another embodiment of the present disclosure. Referring to FIG. 6, based on design constraints or design requirements, the network communication apparatus 1000b may include a various amount of core units in the core groups 200b and 300b, which are different from those of the network communication apparatus 1000 of FIG. 1. The core group 200b in FIG. 6 may include a number “N1b” of core units, being greater than the number “N1” in the example of FIG. 1. Such as, with the number “N1b” equal to “5”, and the core group 200b may include five core units 21b-25b. Since the network communication apparatus 1000b in FIG. 6 include more core units 21b-25b than the core units 21-23 in FIG. 1, the core group 200b of the network communication apparatus 1000b may greatly offload the packet processing.

On the other hand, the core group 300b in FIG. 6 may include a number “N2b” of core unit, e.g., the number “N2b” is “1” being less than the number “N2” in the example of FIG. 1. The core group 300b may include one core unit 31b, and the single core unit 31b performs parallel-to-serial processing for the packets.

The dispatch device 100 receives packets in the packet flows PF1, PF2 and PF3 and is configured to store the packets in the storage unit 500. Furthermore, with a dispatching operation (e.g., based on the “round robin” mechanism or the classification mechanism) the dispatch device 100 is configured to dispatch meta data, which are corresponding to the packets, to the core units 21b to 25b through data flows DF11 to DF15 respectively. The core units 21b to 25b perform parallel processing on the packets in the storage unit 500 based on the received meta data, then the core units 21b to 25b transmit the meta data to the core unit 31b through data flows DF21 to DF25 respectively. The core unit 31b performs serial processing on the packets in the storage unit 500, and then transmits the meta data to the transmitting unit 400 through the data flow DF31. After all, the transmitting unit 400 receives the packets from the storage unit 500, and then transmits packet flows PF1′, PF2′ and PF3′ containing the packets.

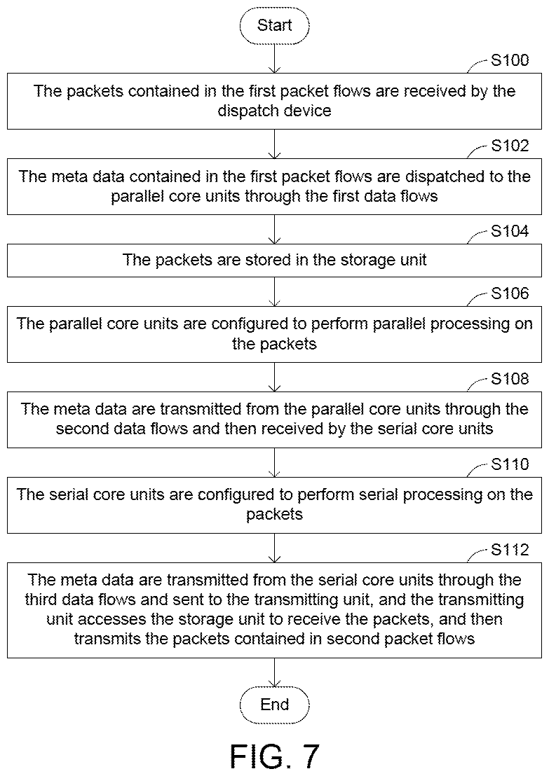

FIG. 7 is a flow diagram of an operating method for the network communication apparatus of the present disclosure. The operating method of FIG. 7 may be applied to the network communication apparatuses 1000 and 1000b of FIGS. 1 and 6. Taking the network communication apparatuses 1000 of FIG. 1 as an example, firstly, in step S100, the packets pk(1-1) to pk(3-3) contained in the packet flows PF1, PF2 and PF3 are received by the dispatch device 100.

Then, in step S102, the meta data md(1-1) to md(3-3) are dispatched to the core units 21-23 by the dispatch device 100, through the data flows DF11 to DF13 respectively. The meta data md(1-1) to md(3-3) may be contained in the packet flows PF1 to PF3, or retrieved from the headers of the packets pk(1-1) to pk(3-3). In one example, the meta data md(1-1) to md(3-3) may be dispatched to the core units 21-23 based on a “round robin” mechanism. In another example, the meta data md(1-1) to md(3-3) may be dispatched to the core units 21-23 based on a classification mechanism, and the core units 21-23 receive meta data based on their classified type.

Then, in step S104, the packets pk(1-1) to pk(3-3) are stored in the storage unit 500 by the dispatch device 100. Then, in step S106, the core units 21-23 are configured to perform parallel processing on the packets pk(1-1) to pk(3-3). Then, in step S108, the meta data md(1-1) to md(3-3) are transmitted from the core units 21-23 through data flows DF21 to DF26, and then received by the core units 31 and 32.

Then, in step S110, the core units 31 and 32 are configured to perform serial processing on the packets pk(1-1) to pk(3-3). Then, in step S112, the meta data md(1-1) to md(3-3) are transmitted from the core units 31 and 32 through data flow DF31 and DF32, and sent to the transmitting unit 400. Furthermore, the storage unit 500 is accessed by the transmitting unit 400 to receive the packets pk(1-1) to pk(3-3). Moreover, the packets pk(1-1) to pk(3-3) contained in packet flows PF1′ to PF3′ are transmitted by the transmitting unit 400.

In conclusion, thanks to the “step-based multi-processor” architecture in conjunction with the “shared memory” provided in various embodiments of the present disclosure, the workload for packet processing for the tunnel network may be greatly offloaded by the core units of different core groups. Furthermore, thanks to the dispatch operation by the dispatch device 100, synchronization efforts may be saved when dispatching packets between core units, especially for packet processing of encapsulation and decapsulation, and workload balancing the packet processing between core units may be greatly achieved. In addition, the core units of different core groups may be adjusted to perform different type of tasks. Such as, some core units are adjusted to perform encapsulation and decapsulation, and some other core units are adjusted to perform fragmentation and reassembly.

In contrast, for a comparative example (not shown in the figures) in which a traditional “flow-based (or tuple-based) multi-processor” architecture is utilized, the core units perform packet processing based on the IP addresses, IP ports or the protocol numbers. In this manner, all packets with the same IP address, the same IP port or the same protocol number will be directed to the same core unit (instead of being dispatched to different core units as the present disclosure). Therefore, severe un-balance of workload among the core units will be caused.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A network communication apparatus, comprising:
a first core group, comprising a plurality of parallel core units;
a dispatch device, for receiving a plurality of packets contained in a plurality of first packet flows, and configured to dispatch a plurality of meta data to the parallel core units through a plurality of first data flows, wherein the meta data contain tunnel parameters of the packets; and
a second core group, comprising at least one serial core unit, wherein the at least one serial core unit receives the meta data from the parallel core units through a plurality of second data flows.

2. The network communication apparatus according to claim 1, wherein the meta data are contained in the first packet flows.

3. The network communication apparatus according to claim 2, wherein the meta data in each of the first data flows have the same order as that the meta data are arranged in the first packet flows.

4. The network communication apparatus according to claim 1, wherein the meta data are retrieved from headers of the packets by the dispatch device.

5. The network communication apparatus according to claim 1, wherein the dispatch device dispatches the meta data to the parallel core units based on a “round robin” mechanism.

6. The network communication apparatus according to claim 1, wherein the dispatch device dispatches the meta data to the parallel core units based on a classification mechanism, and each of the parallel core units receives the meta data based on the classified type.

7. The network communication apparatus according to claim 1, further comprising:
a storage unit, shared and accessible by each of the dispatch device, the parallel core units and the at least one serial core unit;
wherein the dispatch device is configured to store the packets in the storage unit.

8. The network communication apparatus according to claim 1, wherein the parallel core units are configured to perform parallel processing on the packets, and the at least one serial core unit is configured to perform serial processing on the packets.

9. The network communication apparatus according to claim 8, wherein each of the parallel processing and the serial processing is encapsulation, decapsulation, fragmentation or reassembly performed on the packets.

10. The network communication apparatus according to claim 1, further comprising:
a transmitting unit, for receiving the meta data from the at least one serial core unit through at least one third data flow, accessing the storage unit to receive the packets, and transmitting the packets contained in a plurality of second packet flows.

11. An operating method, for operating a network communication apparatus comprising a dispatch device, a first core group with a plurality of parallel core units and a second core group with at least one serial core unit, the operating method comprising:
receiving a plurality of packets contained in a plurality of first packet flows, by the dispatch device;
dispatching a plurality of meta data to the parallel core units through a plurality of first data flows, by the dispatch device; and
receiving the meta data from the parallel core units through a plurality of second data flows, by the at least one serial core unit;
wherein, the meta data contain tunnel parameters of the packets.

12. The operating method according to claim 11, wherein the meta data are contained in the first packet flows.

13. The operating method according to claim 12, wherein the meta data in each of the first data flows have the same order as that the meta data are arranged in the first packet flows.

14. The operating method according to claim 11, wherein the step of dispatching the meta data to the parallel core units comprising:
retrieving the meta data from headers of the packets, by the dispatch device.

15. The operating method according to claim 11, wherein the step of dispatching the meta data to the parallel core units is performed based on a “round robin” mechanism.

16. The operating method according to claim 11, wherein the step of dispatching the meta data to the parallel core units is performed based on a classification mechanism, and each of the parallel core units receives the meta data based on the classified type.

17. The operating method according to claim 11, wherein the network communication apparatus further comprises a storage unit which is shared and accessible by each of the dispatch device, the parallel core units and the at least one serial core unit, and the operating method further comprising:
storing the packets in the storage unit, by the dispatch device.

18. The operating method according to claim 11, further comprising:
configuring the parallel core units to perform parallel processing on the packets; and
configuring the at least one serial core unit to perform serial processing on the packets.

19. The operating method according to claim 18, wherein each of the parallel processing and the serial processing is encapsulation, decapsulation, fragmentation or reassembly performed on the packets.

20. The operating method according to claim 11, wherein the network communication apparatus further comprises a transmitting unit, and the operating method further comprising:
receiving the meta data from the at least one serial core unit through at least one third data flow, accessing the storage unit to receive the packets, and transmitting the packets contained in a plurality of second packet flows, by the transmitting unit.
